(19) United States
(12) Patent Application Publication
(10) Pub. No.: US 2009/0280312 A1
(43) Pub. Date: Nov. 12, 2009

(54) Plate-Shaped Structural Component

(75) Inventors: Stephan Hauser, Langen (DE); Werner Berger, Forchtenberg-Emsbach (DE)

Correspondence Address: GUDRUN E. HUCKETT DRAUDT, SCHUBERTSTR. 15A, WUPPERTAL, 42289, DE

(73) Assignee: DUCOSTONE GMBH, Wurzburg (DE)

(21) Appl. No.: 12/307,749

(22) PCT Filed: Jun. 19, 2007
(86) PCT No.: PCT/DE2007/000955

§ 371 Date: Jan. 7, 2009

(30) Foreign Application Priority Data
Jul. 7, 2006 (DE) 20 2006 010 610.3
Apr. 13, 2007 (DE) 20 2007 005 496.3

(51) Int. Cl. B32B 15/02; B32B 27/06

(52) U.S. Cl. 428/220; 442/1

(57) ABSTRACT

A plate-shaped structural component has a concrete substrate that contains a reinforcement mesh of several micro-plies with a respective mesh width of approximately 5 to 60 mm. At least one additional panel is attached sandwich-like on the concrete substrate by mechanical anchoring and by adhesive connection.

The invention concerns a plate-shaped structural component comprised of a concrete substrate that comprises a reinforcement mesh of several micro-plies having a mesh width of approximately 5-60 mm.

In a concrete substrate disclosed in EP 1 153 171 B1 (=WO 2001/23685) micro-plies are designed and arranged such that across the thickness of the reinforcement mesh a change of the mesh or opening width is present in such a way that during manufacture of the concrete substrate during cement mortar or concrete infiltration concrete aggregate bodies of different sizes are sorted and distributed across the reinforcement mesh thickness, ordered according to their size, substantially in predetermined positions and in a targeted distribution. Such a structural component, because of the structure of the substrate, is distinguished by high strength, in particular in regard to explosions or fired shots. When manufacturing such a plate-shaped structural component the screening effect can be achieved by variation of the mesh width and/or by displacement of plies of same mesh width that are stacked on top or adjacent one another.

The invention has the object to provide a plate-shaped structural component that can be used preferably as a façade element, a wall element or a ceiling element and that, relative to a simple concrete panel, has a deviating visible face.

As a solution to this object the plate-shaped structural component is characterized in that at least one additional panel, made preferably of natural stone, glass, wood or timber-based material, metal and/or plastic material, cardboard/paperboard, multi-ply paper material, is attached sandwich-like to the substrate, preferably by gluing and/or optionally by means of mechanical anchoring elements.

In particular for additional panels of a material with high specific weight, for example, natural stone, glass, metal, the additional mechanical anchoring on the substrate is provided. By a permanently elastic adhesive connection of a panel of natural stone, glass and also wood on the concrete substrate the object is solved that for short-term dynamic loads, for example, explosions and/or other sudden impacts, the fragment formation of the additional panel is reduced in that a substantial volume proportion of the panel remains adhered to the substrate. Static loads, for example, wind force and wind suction, are received by the additional mechanical anchoring means and by the adhesive connection.

A preferably permanently elastic adhesive connection enables the compensation of temperature-dependent elongation differences of the different materials. Such a configuration is used preferably as curtain walling. According to a further invention it is provided that on the substrate in both faces additional panels are attached by gluing and/or mechanically so that the structural component is especially suitable as an interior wall element.

According to a further invention it is provided that the micro-plies are dimensionally of the same configuration and are preferably congruently or almost congruently arranged on top one another.

Between the individual plies of the reinforcement mesh, spacer bodies are preferably provided that have already been integrated before carrying out the cement mortar or concrete infiltration into the ply mesh.

According to a further invention it is provided that between the substrate and the additional panel, for example, natural stone panel, a thermal insulation and/or thermal absorption layer is provided wherein panels with high specific weight are anchored on the substrate by anchoring elements that penetrate this layer. In this case it is also provided that adhesive layers between the substrate and the thermal insulation and/or thermal absorption layer, on the one hand, and the thermal insulation and/or thermal absorption layer and the additional panels, on the other hand, are provided. Elongation differences of the different materials are also compensated by the transverse deformation capability of the thermal insulation and/or thermal absorption layer when this layer is glued to form a complete composite structure with the two panels. This configuration is preferably used as curtain walling.

The invention with be explained in the following with the aid of the drawing in more detail.

The FIGS. 1 and 1a show section views of the plate-shaped structural component according to the invention, comprised of a substrate 1 to which on one face or both faces, as a function of the respective sizes, at least one additional panel 2 is glued optionally by using a permanently elastic adhesive. The concrete substrate 1, depending on the application and the posed requirements, have a thickness preferably in the range of 15-250 mm. The concrete substrate 1 comprises a reinforcement mesh that is formed of at least two plies, preferably in the form of welded wire mesh layers, fiberglass web, plastic material webs or the like. A welded wire mesh layer is comprised in particular of wires with the wire diameter in the range of 0.5 to 3,5 mm and has mesh width in the range of approximately 5-60 m.

The additional panels 2 according to the invention can be comprised of the following materials with the indicated thickness.

| Material | thickness |
|---|---|
| natural stone | 10-70 mm |
| glass | 4-25 mm |
| wood/timber-based material | 3-30 mm |
| cardboard/paperboard | 2-10 mm |
| metal | 1-30 mm |
| plastic material | 3-30 mm |
| multi-layer paper material | 2-30 mm |

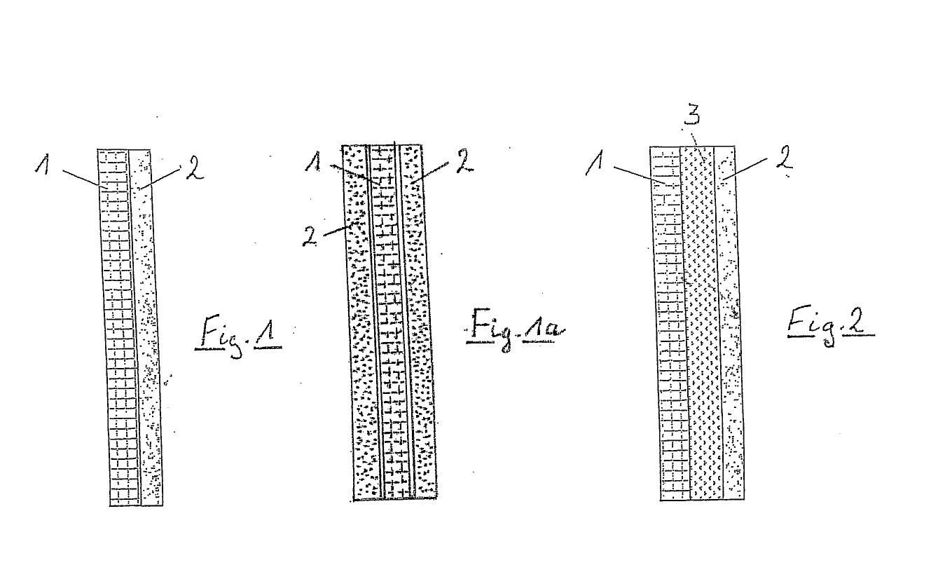

In the embodiment according to FIG. 2 on the concrete substrate 1 a thermal insulation and/or thermal absorption layer 3 is attached, preferably by an adhesive connection, on which, in turn, an additional panel 2 is attached: preferably also by an adhesive connection. The additional thermal insulation and/or thermal absorption layer 3 is comprised preferably of a pressure-resistant thermal and/or thermal absorption material and has a thickness in the range of 10-150 mm.

In the case that the structural component according to the invention is used as an exterior façade element for a building, the individual plate-shaped structural component can be anchored to the ceilings, respectively In case of retrofitting an existing building the plate-shaped structural component according to the invention can be used as curtain walling on an existing façade. The use as curtain walling can also be employed in new buildings, in particular as curtain walling on a load-bearing armored concrete exterior wall in sensitive building areas. In this connection, the plate-shaped structural component according to the invention is also anchored at the ceiling level, respectively.

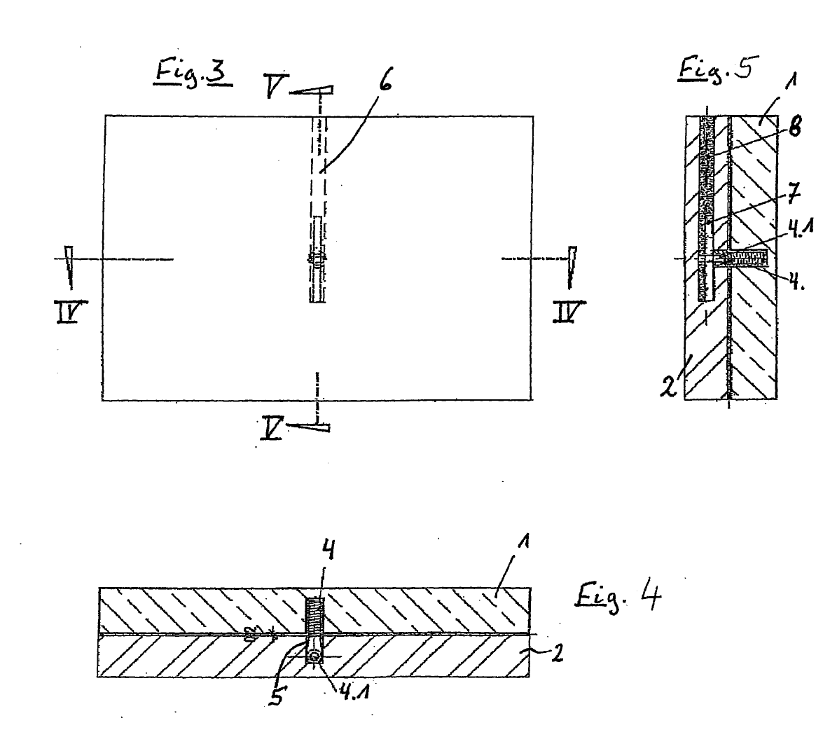

According to FIGS. 3 to 5 a panel 2 comprised of natural stone is attached to the substrate 1 by means of at least one anchor 4 that with a first end is either embedded in the substrate 1 or screwed in. The individual natural stone panel is provided at the face opposite the substrate 1 with at least one blind bore 5 into which an anchor 4 anchored in the substrate 1 projects with its end provided with an eye 4.1. Each blind bore 5 has correlated therewith a blind bore 6 that begins at an outer edge surface of the natural stone panel and that intersects the blind bore 5 at a right angle in such a way that through this blind bore 6 an anchoring pin 7 can be inserted so as to pass through the eye 4.1. The remaining unoccupied volume of the blind bore 6 is filled with a casting compound 8. Such a plate-shaped structural component has a total thickness in the range of approximately 20 to 320 mm.

What is claimed is:

1.-32. (canceled)

33. Plate-shaped structural component comprising:
a concrete substrate that comprises a reinforcement mesh of several micro-plies with a respective mesh width of approximately 5 to 60 mm;
at least one additional panel attached sandwich-like on the concrete substrate by mechanical anchoring and by adhesive connection.

34. Plate-shaped structural component according to claim 33, wherein the at least one additional panel is a natural stone panel.

35. Plate-shaped structural component according to claim 33, wherein the mechanical anchoring comprises an anchor that is anchored with a first end in the concrete substrate by being embedded with the first end in the concrete substrate or by being screwed with the first end into the concrete substrate.

36. Plate-shaped structural component according to claim 35, wherein the at least one additional panel is a natural stone panel having a face opposite the concrete substrate, wherein the face is provided with at least one first blind bore, wherein the anchor has a second end provided with a fastening eye and the second end with the fastening eye projects into the at least one first blind bore, wherein the at least one additional panel has for each one of the at least one first blind bore a second blind bore that intersects perpendicularly the correlated first blind bore, wherein a securing pin is inserted into the second blind bore and passes through the fastening eye of the anchor, wherein a volume of the second blind bore that is not occupied by the securing pin is filled with a casting compound.

37. Plate-shaped structural component according to claim 36, wherein the concrete substrate has a thickness of approximately 15 to 250 mm and the natural stone panel has a thickness of 10 to 70 mm.

38. Plate-shaped structural component according to claim 37, having a total thickness of approximately 25 to 320 mm.

39. Plate-shaped structural component according to claim 33, further comprising a thermal insulation and/or thermal absorption layer arranged between the concrete substrate and each one of the at least one additional panel, wherein the thermal insulation and/or thermal absorption layer has a first face and a second face, wherein the first face is glued to each one of the at least one additional panel and the second face is glued to the concrete substrate, wherein the mechanical anchoring comprises an anchor for each one of the at least one additional panel, and wherein each one of the at least one additional panel is attached to the concrete substrate by the anchor that is penetrating the thermal insulation and/or thermal absorption layer.

40. Plate-shaped structural component according to claim 39, wherein the thermal insulation and/or thermal absorption layer is comprised of a pressure-resistant thermal insulation and/or thermal absorption material and has a thickness of approximately 10 to 150 mm.

41. Plate-shaped structural component according to claim 33, wherein the micro-plies of the reinforcement mesh are designed and arranged such that across a reinforcement mesh thickness a change of mesh width of the micro-plies exists, wherein the change of mesh width is realized such that during manufacture of the concrete substrate during cement mortar or concrete infiltration concrete aggregate bodies of different size are distributed in a targeted way, ordered according to size, across the reinforcement mesh thickness.

42. Plate-shaped structural component according to claim 33, wherein the reinforcement mesh is comprised of welded wire mesh layers with wire diameters of approximately 0.5 to 3.5 mm.

43. Plate-shaped structural component according to claim 33, wherein the at least one additional panel is glued by a permanently elastic adhesive to the concrete substrate.

44. Plate-shaped structural component according to claim 33, wherein several of the at least one additional panel are provided and attached to both faces of the concrete substrate.

45. Plate-shaped structural component according to claim 33, wherein the micro-plies dimensionally have the same configuration and are arranged congruently on top one another.

46. Plate-shaped structural component according to claim 33, comprising spacers between the individual micro-plies which spacers have been integrated into the reinforcement mesh before concrete infiltration.

47. Plate-shaped structural component according to claim 33, wherein the at least one additional panel is comprised of glass having a thickness of 4 to 25 mm.

48. Plate-shaped structural component according to claim 33, wherein the at least one additional panel is comprised of wood/timber-based material with a thickness of 3 to 30 mm.

49. Plate-shaped structural component according to claim 33, wherein the at least one additional panel is comprised of cardboard/paperboard having a thickness of 2 to 10 mm.

50. Plate-shaped structural component according to claim 33, wherein the at least one additional panel is comprised of metal having a thickness of 1 to 30 mm.

51. Plate-shaped structural component according to claim 33, wherein the at least one additional panel is comprised of plastic material having a thickness of 3 to 30 mm.

52. Plate-shaped structural component according to claim 33, wherein the at least one additional panel is comprised of a multi-layer paper material having a thickness of 2 to 30 mm.

53. Plate-shaped structural component according to claim 33, wherein the concrete substrate has a thickness of approximately 15 to 250 mm.
